(19) United States
(12) Patent Application Publication
(10) Pub. No.: US 2005/0044269 A1
(43) Pub. Date: Feb. 24, 2005

(54) Role generation method and device for elements in a communication network, on the basis of role templates

(75) Inventor: Hanine Abdelkrim, Paris (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/919,297

(22) Filed: Aug. 17, 2004

(30) Foreign Application Priority Data
Aug. 19, 2003 (FR) 03 10 000

(51) Int. Cl. G06F 15/173

(52) U.S. Cl. 709/238; 370/235

(57) ABSTRACT

A device or arrangement (D) is dedicated to role generation for network elements (NEL) or equipment (NEQ) in a communication network, capable of performing traffic processing defined by policy rules stored in a first memory (MI) and referenced to role definitions. The device or arrangement (D) includes processing resources (MT) which are responsible, when they receive a request for the creation of a role, for associating this role with the identifier of a role template chosen from role templates stored in a second memory (M2), where each includes a set of at least one constraint associated with a function performed by a managed type of network element (NEL), and of defining the role by a set of at least one managed network element satisfying at least one of the constraints on the associated role template, where each constraint must also be satisfied by at least one of the network elements (NEL) of the set.

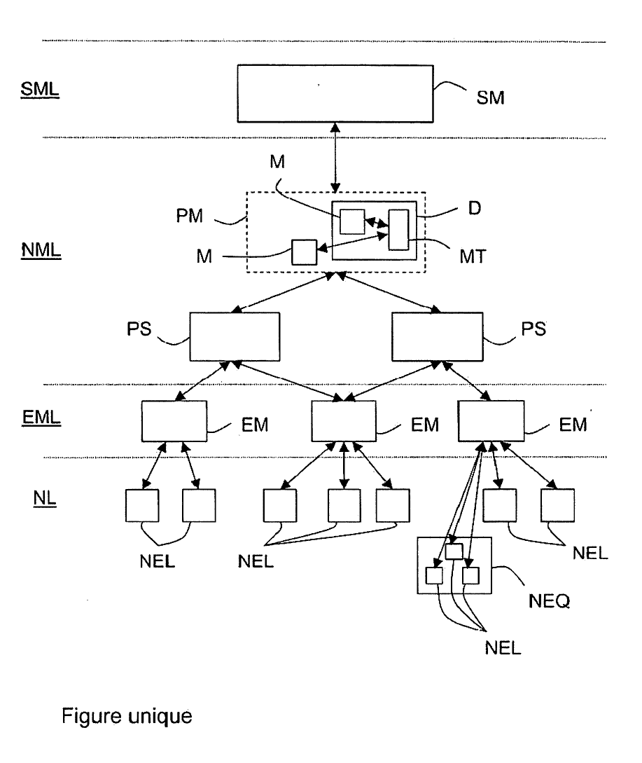

The invention concerns the area of management of equipment and equipment elements in a communication network having a network management system of the “policy rules” type.

In the above-mentioned communication networks, the network equipment and/or elements, or more generally the resources, are managed in accordance with a policy that is defined by policy rules. A policy rule is a rule of the type “if <condition> then <action>”.

The policy rules determine traffic processings, generally associated with services to be performed by the network elements or equipment when they have instituted them.

Here, “network equipment” refers to all types of hardware, such as servers, terminals, switches, routers or concentrators for example, capable of exchanging data, in particular management data with the network management system of the network to which it belongs, in accordance with a network management protocol. The network management protocol can be the SNMP protocol for example (Simple Network Management Protocol RFC 2571-2580), used in particular in the networks of the IP or ADSL type, the TL1 protocol used in particular in the networks of the SONET type, the Q3 protocol used in particular in the networks of the SDH type, or indeed the CLI (command line) and CORBA protocols.

In addition, here “network element” refers to any component of a network equipment item, which is capable of performing traffic handling, such as a card, an interface, a shelf, or a rack, for example.

Furthermore, “traffic” can refer to either a stream of data packets or a single packet of data.

In some of the above-mentioned networks, the policy rules are associated with roles which define the parts of the network concerned by the application of policy rules. In other words, a role is composed of a set of managed elements and/or equipment items.

This notion of “role” is defined, for example, in document RFC 3060 taken from the IETF (Internet Engineering Task Force) and entitled a PCIM (Policy Core Information Model), dating from February 2001. This notion of role was applied in the solutions presented in the American patents U.S. Pat. No. 5,872,928 and U.S. Pat. No. 6,587,876 for example.

Chronologically, the operator (or supervisor) of a network begins by assigning the roles to the resources in order to facilitate compliance with the service level agreements (SLAs) made with the customer or customers concerned. Then he prepares one or more policy rules which he associates with one or more roles, using a policy manager which beholds to the network management system (NMS). The policy rules are then transmitted to a policy server which is responsible for validating them, storing them, and transmitting them selectively (using the roles) to the equipment concerned, in order that they will institute them, generally by means of element management modules.

Because of the method used for generation of the roles, errors can occur. Generally, the error concerns the incompatibility of an element or of an equipment item with policy rules associated with the role assigned to them. For example, in a internet protocol (IP) network, the interface of a router supports the simple processing of IP packets, but does not support processes of the BGP/MPLS VPN type, which nevertheless have been assigned to it by policy rules.

The purpose of the invention is therefore to avoid such errors happening in the definition of roles during their generation.

To this end, it proposes a method that is dedicated to role generation for managed elements or equipment in a communication network, capable of performing traffic processing, such as that associated with services offered by the network, and defined by policy rules associated with role definitions.

This method is characterised by the fact that it consists, every time a role must be created, of associating this role with the identifier of a role template chosen from role templates where each includes a set of at least one constraint associated with a function provided by a managed type of network element, and then defining the role by a set of at least one managed network element which satisfies at least one of the constraints on the associated role template, where each constraint must also be satisfied by at least one of the network elements of the set.

When the set of constraints consists of only a single constraint, each element of the role must observe this constraint. On the other hand, when the set of constraints includes several constraints, each element of the role must observe one or more constraints, or even all of them, depending on what is defined, and in accordance with the procedures defined in the role template.

The invention also proposes an device which is dedicated to role generation for the elements or equipment of a communication network, capable of performing traffic processing, associated with services offered by the network for example, and defined by policy rules stored in a first memory and referenced to role definitions.

This device is characterised by the fact that it includes processing means that are responsible, when they receive a role creation request, of associating this role with the identifier of a role template chosen from role templates stored in a second memory, where each includes a set of at least one constraint associated with a function performed by a managed type of network element, and for defining the role by means of a set of at least one managed network element satisfying at least one of the constraints on the associated role template, where each constraint must also be satisfied by at least one of the network elements of the set.

Preferably, the processing means are capable of storing the definitions of the roles created, in the first memory, and referenced to the policy rules and of the identifier of the associated role patters.

In addition, the device according to the invention can include the first memory and/or the second memory.

Whether it concerns the method or the device according to the invention, the constraints preferably designate a function performed by a managed type of network element according to at least one of its capabilities and/or one or more role templates.

The invention also proposes a policy manager for a network management system (NMS), equipped with a device of the type presented above.

The invention is particularly well suited, though in a non-exclusive manner, to communication networks such as transmission networks (of the WDM, SONET or SDH type, for example), data networks (of the IP-Internet or ATM type, for example), voice networks (of the conventional or mobile type for example) or mixed voice-data networks (of the NGN type, example).

Other characteristics and advantages of the invention will be seen on studying the following detailed description and the appended drawing, in which the single FIGURE schematically illustrates an example of the creation of a communication network equipped with an device or arrangement for role generation according to the invention. The appended drawing can not only serve to complete the invention, but acan also contribute to its specification, where appropriate.

The purpose of the invention is to allow role generation for equipment and elements of a communication network managed by policy rules.

In what follows, we consider, as an illustrative example, that the communication network is at least partially of the internet protocol (IP) type. But the invention also applies to other types of network, such as, for example, transmission networks of the WDM, SONET or SDH type, data networks of the ATM type, voice networks of the conventional or mobile type, or indeed mixed voice-data networks such as those of the NTN type.

As illustrated in the single FIGURE, a communication network of the managed type can be broken down schematically into four layers—a first layer called the services management layer (SML), a second layer coupled to the SML layer and called the network management Layer (NML), a third layer coupled to the NML layer and called the element management layer (EML), and a fourth layer coupled to the EML layer and called network layer (NL).

The first (SML), second (NML) and third (EML) layers define, at least in part, the network management system which is intended to allow the manager (or supervisor) of the network to remotely manage and monitor the NEQ equipment to which it is coupled.

The fourth layer (NL) includes a multiplicity of network elements (NEL) which, either when they are alone or when they are grouped, constitute network equipment items (NEQ) connected to each other by communication means. In other words, an item of network equipment (NEQ) is a hardware item composed of at least one network element (NEL).

Each network equipment element (NEQ) is capable of exchanging management data with the management system (NMS), in accordance with a chosen management protocol, such as the SNMP protocol (Simple Network Management Protocol RFC 2571-2580) for example, or the TL1, CORBA, CLI or Q3 protocols. As an example, an item of network equipment (NEQ) can be an edge or core server, a terminal, a switch, a router or a concentrator.

In addition, a network element (NEL) here means any component of an item of network equipment (NEQ) capable of performing at least one traffic processing, such as, a card, an interface, a shelf, or a rack for example. Such a network element (NEL) can therefore be defined by one or more capabilities which define its ability to perform a function within the network, such as to conditioning or packaging data packets, or converting network addresses, for example, or indeed performing a processing of the BGP/MPLS VPN SAP (Service Access Point) type.

The first SML layer is composed of a service manager (SM), translating service level agreements (SLA), concluded between the operator of the network and its customers, into policy rules.

These policy rules define, by group, policies prepared by the operator so as to satisfy the service level agreements (SLA). They are intended to define the traffic processings (or functions) that the different network equipment elements (NEQ) and their network elements (NEL) must carry out in order to implement the services offered by the network, such as a service of the virtual private network (IP VPN) type for example.

The second NML layer is composed of a policy manager (PM), supplied with policy rules by the service manager (SM), and one or more policy servers (PS) coupled to the policy manager (PM).

The policy manager (PM) mainly allows the administrator of the network, or its operator, to associate roles with policy rules.

Each policy server (PS) is responsible for validating the policy rules that it receives from the policy manager (PM), to store them in a memory, and to transmit them selectively to the third EML layer.

The second EML layer is composed of one or more equipment management modules or element management (EM) modules which are responsible for providing the dialogue interface between the network management system (NMS) and its first SML and second NML layers in particular, and the NEQ equipment (or NEL elements) of the network to which they are respectively coupled. For example, each element management module (EMS) is installed in a management server. But it could also be installed in an item of network equipment (NEQ) (referred to as an on-board agent), accessed by a terminal dedicated to local equipment management, also known as a craft terminal.

As indicated previously, the object of the invention is to allow role generation for managed NEL elements (or equipment items (NEQ)) in a communication network. To this end, it proposes a role generation device (D) which includes a processing module (MT) which, whenever it receives a role creation request, is responsible for associating the said role with the identifier of a role template.

This role template is chosen by the operator or the administrator of the management network, from role templates which each includes a set of at least one constraint associated with a function performed by a type of managed element (NEL) (or equipment item (NEQ)) in the network. In other words, a role template is composed of a set of constraints relating to certain elements and equipment in the network.

A constraint comes in the shape of a basic role (or function) and/or of one or more role templates (it can indeed constitute a concatenation of templates).

A basic role is a function performed by a type of managed network element (NEL), according to at least one of its actual capabilities (in the definition given previously). It can also be defined as a method of using at least one actual capability of a managed network element (NEL).

The basic role of a managed element (NEL) is chosen in accordance with the way in which one of its capabilities can be used to implement all or part of a service, from the viewpoint of the network operator. As a non-limited example, in the case of the putting in place of a service of the IP VPN type, an interface with a processing capability of the BGP/MPLS VPN type can be used as a service access point (SAP) in order to perform BGP/MPLS VPN processings. In this case, the operator can define the basic BGP/MPLS VPN SAP role and then associate it with the aforementioned interface (or the interface type).

It is important to note that, to the extent that a managed equipment element (NEQ) can have several capabilities, several basic roles can be associated with it. In addition, since the same capability can be possessed by several managed elements (NEL) (or equipment items (NEQ)), then the same basic role can be associated with several managed elements (NEL) (or equipment items (NEQ)), giving rise to the notion of the element type.

By virtue of this definition, a role template called VPN, associated with a service of the IP VPN type, can thus be composed of a set of basic roles of the above-mentioned BGP/MPLS VPN SAP type.

Once created, these role templates are stored by the processing module (MT) in a memory (M2) to which it is coupled, and which preferably forms part of the device (D) according to the invention.

The device (D) is preferably incorporated into the policy manager (PM) of the network which associates the policy rules with roles in accordance with the information transmitted to it via a graphical interface (not shown), of the graphical user interface (GUI) type in the management system (NMS).

The device (D) can thus receive from the graphical interface (GUI) the role creation requests formed by the operator, can satisfy these, and then communicate the definition of each new role created to the rule generation module of the policy manager (PM) so that it generates the associated policy rule or rules. In addition, the processing module (MT) can receive from the graphical interface (GUI) the definitions of the basic roles and of the role templates which are, for example, designed by a network management administrator.

According to the invention, when the processing module (MT) has associated a role with the identifier of a role template, it then defines the role. This consists of regrouping, into a set, one or more managed network (or equipment) elements, each of which satisfies at least one of the constraints on the associated role template, and where each constraint must also be met by at least one of the network elements (NEL) of the set. In accordance with what has been defined in the role template, each element of a set must satisfy one or more constraints, or even all of them. Furthermore, each element of a set must satisfy the constraint(s) in accordance with the procedures defined in the said role template.

For example, the processing module (MT) has associated the “VPN” role template with a “VPN-A” role, so that each element (NEL) of the set constituting the VPN-A role fills at least one of the basic roles (there may possibly be just one of these) grouped within the VPN role template.

Using the policy manager (PM), the operator then chooses the policy rules which must be associated with the role that has just been created. Then the definition of the role created is stored in a memory (MI) and referenced to the associated policy rules and to the identifier of the associated role template.

It is preferably the processing module (MT) of the device (D) which is responsible for this storage method.

The memory (MI) forms part of the second NML layer in order to be accessible to the policy manager (PM) and to the policy servers (PS), as well as to the third EML layer where appropriate. For example, this memory (M1) is incorporated into the policy manager (PM) possibly in the device (D).

Once policy rules have been associated with a role definition, they can be transmitted, by request, to each Policy Server (PS) concerned, so that the latter can sent them to the network elements (NEL) and/or equipment items (NEQ) designated by the associated role and which have to implement them.

Where appropriate, the transmission of the policy rules to the elements and/or equipment concerned can take place in accordance with a model in layers adapted to the network example illustrated in the single FIGURE.

To this end, the relations that exist between the different layers are defined so that a layer (n) is in possession of information indicating which elements (NEL) and/or equipment items (NEQ) are managed by layer n+1 positioned just below it. Thus, when layer n receives policy rules associated with a role from layer n−1, it only has to determine the portion or portions of layer n+1 to which it must itself transmit them, using the definition of the role.

The generation device (D) according to the invention, and in particular its processing module (MT), as well as its memory (M2) and/or memory M1 where appropriate, can be implemented in the form of electronic circuits, of software (computer) modules, or a combination of circuits and software.

The invention also offers a method which is dedicated to role generation for managed elements (NEL) (or Equipment items (NEQ)) in a communication network, capable of performing traffic processing, associated with services offered by the network, and defined by policy rules associated with role definitions for example.

In particular, this can be implemented using the role generation device (D) and the policy manager (PM) presented above. Since the main and optional functions and sub-functions performed by the stages of this method are more or less identical to those performed by the different means constituting the role generation device (D) and/or the policy manager (PM), then only the stages implementing the main functions of the method according to the invention will be summarised below.

This method consists, every time a role has to be created, of associating this role with the identifier of a role template chosen from role templates where each one has a set of at least one constraint associated with a function performed by a managed type of network element (NEL), and then of defining the role by a set of at least one managed network element (NEL) which satisfies at least one of the constraints on the associated role template, and where each constraint must also be satisfied by at least one of the network elements of the set.

The invention is not limited to the embodiments of the role generation device, of the policy manager and of the role generation method described above by way of example only, but covers all variants that can be envisaged by the professional engineer in the context of the following claims.

1. A role generation method for managed elements (NEL) in a communication network, which are arranged so as to perform traffic processing as defined by policy rules associated with role definitions, characterised in that it comprises, in the event of a request for the creation of a role, associating said role with an identifier of a role template chosen from role templates where each includes a set of at least one constraint associated with a function performed by a managed type of network element, and then defining said role by a set of at least one managed network element (NEL) satisfying at least one of the said constraints on the associated role template, where each constraint must also be satisfied by at least one of the network elements (NEL) of the set.

2. A method in accordance with the claim 1, characterised in that certain constraints designate a function performed by a managed type of network element (NEL) according to at least one of its capabilities.

3. A method in accordance with the claim 1, characterised in that certain constraints on a role template designate at least one role template.

4. A method in accordance with the claim 1, characterised in that said traffic processing is associated with services offered by said network.

5. A role generation device (D) for managed elements (NEL) in a communication network, arranged to perform traffic processing defined by policy rules stored in a first memory (M1) and referenced to role definitions, characterised in that it includes processing means (MT) able to, on receipt of a request for the creation of a role, associate the said role with an identifier of a role template chosen from of the role template stored in a second memory (M2), where each includes a set of at least one constraint associated with a function performed by a managed type of network element (NEL), and to define said role by means of a set of at least one managed network element (NEL) satisfying at least one of said constraints on the associated role template, where each constraint must also be satisfied by at least one of the network elements (NEL) of the set.

6. A device in accordance with the claim 5, characterised in that said processing means (MT) are arranged to store the definition of a created role in said first memory (M1) and referenced to associated policy rules and to the identifier of the associated role template.

7. A device in accordance with claim 5, characterised in that it includes said second memory (M2).

8. An device in accordance with claim 5, characterised in that it includes said first memory (M1).

9. A device in accordance with claim 5, characterised in that certain constraints designate a function performed by a managed type of network element (NEL) according to at least one of its capabilities.

10. A device in accordance with claim 5, characterised in that certain constraints on a role template designate at least one role template.

11. A device in accordance with claim 5, characterised in that the traffic processing is associated with services offered by said network.

12. A policy manager (PM) of a network management system in a communication network that includes a multiplicity of managed network elements (NEL) arranged to perform traffic processing defined by policy rules associated with role definitions, characterised in that it includes an device (D) according to claim 5.

13. Use of the device (D), of the policy manager (PM), and of the method, in accordance with claim 5, in the transmission networks, in particular of the WDM, SONET and SDH type, in the data networks, in particular of the IP-Internet and ATM type, in the voice networks, in particular of the conventional or mobile type, and in the mixed voice-data networks, in particular of the NGN type.
